(19) United States
(12) Patent Application Publication
(10) Pub. No.: US 2024/0001568 A1
(43) Pub. Date: Jan. 4, 2024

(54) DEVICE FOR HANDLING CLOSURES INSIDE A CLEAN ROOM, A CLEAN ROOM COMPRISING A CORRESPONDING DEVICE, AND A METHOD FOR HANDLING CLOSURES INSIDE A CLEAN ROOM

(71) Applicant: Syntegon Technology GmbH, Waiblingen (DE)

(72) Inventors: Stefan Nagler, Unterschneidheim (DE); Ulrich Krauß, Ilshofen (DE); Markus Ilgenfritz, Feuchtwangen (DE); Juergen Leidig, Frankenhardt (DE); Patrick Holl, Crailsheim (DE)

(21) Appl. No.: 18/255,450

(22) PCT Filed: Nov. 29, 2021
(86) PCT No.: PCT/EP2021/083270

§ 371 Date: Jun. 1, 2023

(30) Foreign Application Priority Data
Dec. 15, 2020 (DE) 10 2020 133 609.8

(51) Int. Cl. B25J 21/00; B25J 19/02; B25J 9/00; B65B 7/28; B65B 57/02; B65B 3/00; B65B 55/02

(52) U.S. Cl. CPC B25J 21/005; B25J 19/023; B25J 9/0096; B65B 55/027; B65B 57/02; B65B 3/006; B65B 7/2814

(57) ABSTRACT

A device (10) for handling closures (12) inside a clean room, in particular in a sterile environment, a clean room with a corresponding device (10) and a method for handling closures (12) within a clean room, in particular in a sterile environment, are proposed.

### BACKGROUND

The filling of active medical ingredients takes place in special filling and capping systems. Particularly in the case of aseptic filling and filling of toxic and highly potent active ingredients, filling takes place under strict sterility requirements in an isolator or clean room.

In filling and capping lines, vibratory conveyors or centrifugal conveyors are generally used to feed and align loose closure components. Here, the closure components are guided in lanes and sorted via baffles.

When feeding closure components with a vibratory conveyor or a centrifugal conveyor, malfunctions may occur due to jammed closure components on the feed line.

These malfunctions must be rectified by operator intervention. For this purpose, the isolator is usually equipped with a glove port that allows an operator to gain manual access and rectify the malfunction. Automatic troubleshooting is not possible because the closure components can jam at any point on the conveyor and the malfunction can therefore occur at different points.

### SUMMARY

The task of the present invention is to provide a device for handling closures inside a clean room, a clean room with a corresponding device, and a method for handling closures inside a clean room with which the closures can be handled in a process-safe manner and can be applied to a container, for example.

This task is solved by a device for handling closures inside a clean room (e.g. an isolator of a pharmaceutical machine), in particular in a sterile environment. The device comprises:

A receptacle for receiving at least one closure, in particular a plurality of closures.

A handling device, in particular a robot arm, with a tool. The tool is designed to be able to handle at least one closure.

The tool can be a vacuum suction cup, electrically or pneumatically driven gripper, or a contact surface on the end effector equipped with a microstructured polymer film (gecko effect).

A sensor device designed to detect a position, a type (e.g. different size and/or color), an orientation and/or a possible damage of the closure within the receptacle. It is equally conceivable that the sensor device monitors the fill level of the receptacle. In other words, the sensor device may be arranged to detect the number of closures received in the receptacle.

The device also has a vibration device. This is designed to vibrate the receptacle in such a way that the orientation and/or position of the closure received in the receptacle, in particular a plurality of closures, in particular all closures, received in the receptacle is/are changed as a result of the vibration.

It is conceivable that the closure received in the receptacle can be changed in its orientation and/or position only in a part of the receptacle, but in particular in the entire receptacle, due to the vibration. The vibration device can be designed to vibrate the receptacle directly (by means of direct contact). It is also conceivable that the vibration device can be designed to vibrate the receptacle indirectly, in particular by means of at least one intermediate coupling element (without direct contact).

The number of individual components of the device can vary. For example, several, in particular two, receptacles, handling devices and/or sensor devices can also be used.

The device can be used in a barrier system. All components used can be designed in such a way that they can be used in the sterile pharmaceutical environment.

A clean room in the present sense may be a barrier system, e.g., RABS (Reduced Access Barrier System), an isolator (e.g., aseptic or cytotoxic isolator), or a biosafety cabinet. A clean room in this sense may be pressurized to prevent or minimize the risk of contamination intrusion. Alternatively, a clean room in this sense can also be operated under negative pressure to prevent the escape of any toxic or otherwise hazardous substances to be handled in the clean room.

The closures can be moved, in particular poured, from a hopper system (e.g. linear conveyor, bags, containers), or manually onto the receptacle.

The receptacle can be tablet-shaped, for example. The receptacle can be essentially rectangular. The receptacle can be formed in one piece. The receptacle can have a flat receiving surface. In particular, the receptacle may be configured such that the closures can move freely throughout the receptacle or the receiving surface thereof. The receptacle may have an edge that bounds the receiving surface. The edge may protrude from an extension plane of the receiving surface. The edge may at least partially, in particular completely, enclose the receiving surface. The edge may be oriented orthogonally to the plane of extension of the receiving surface.

The handling device can be designed to be able to move the tool with respect to the direction of gravity over the entire receiving surface, in particular over the entire receptacle. In particular, the handling device can be designed to be able to move the tool within a plane parallel to the extension plane of the receiving surface. In particular, the handling device is designed in such a way that it can pick up or grip closures at various, in particular arbitrary, points of the receptacle or the receiving surface.

In this context, “handling” can mean gripping, fixing, releasing, holding and/or transporting. Gripping can mean clamping fixation in all three spatial directions.

In particular, the handling device is designed in such a way that it can pick up closures from the receptacle or receiving surface and transport them to another location and deliver them there.

It is conceivable that the handling device has several, in particular two, tools. The several tools can be coupled with each other in such a way that all tools are moved simultaneously and in the same way by means of the handling device. It is also conceivable that the handling device has an adjustment device with which the several tools can be moved relative to one another.

According to a further development, the sensor device can have at least one illumination device. This can be designed to illuminate the receptacle. Advantageously, the illumination device is one or more LEDs (light-emitting diodes), which are arranged in particular on the sensor device and/or in the immediate vicinity of the sensor device. The illumination device can be oriented in such a way that the receptacle and/or the closures received in the receptacle are illuminated, in particular illuminated from above. Such illumination can optimize the detection of the closures or their position, type, orientation and/or possible damage.

The illumination device can be static (i.e. immovable) and, in particular, arranged above the receptacle in relation to the direction of gravity. It is also conceivable that the illumination device is designed to be movable, in particular in relation to the direction of gravity above the receptacle. In this way, the lighting device can be optimally adjusted to illuminate the closures.

The sensor device can have at least one camera for detecting the closure. This can be designed to take images and/or video recordings in the visible and/or non-visible spectral range (e.g. infrared, ultraviolet) of the receptacle or of the closure (or several closures) received in the receptacle.

It is conceivable that the sensor device is designed statically (i.e. immovably) and is arranged above the receptacle, in particular with respect to the direction of gravity. It is also conceivable that the sensor device is designed to be movable, in particular in relation to the direction of gravity above the receptacle.

The sensor device can be designed to be able to detect at least a part of the receptacle, in particular the entire receptacle. The sensor device can be designed to be able to capture (detect), in particular simultaneously, all closures received in the receptacle.

The receptacle can be in the form of a plate. This can have an edge and/or, in particular, be of shell-like or tub-like design. In this way, a receptacle can be provided in a simple constructive manner which can securely receive the closure or closures.

The receptacle can have a structure. This can be designed to influence the position and/or orientation of the closure(s) during vibration of the receptacle. The structure may be formed as recesses/depressions and/or as elevation(s), e.g., slot-like. The structure may have depressions formed complementary to the closures, in particular the depressions are complementary to the closures such that a closure is held in only one orientation in one of the depressions. In particular, the device may comprise one or more corresponding closures.

The device can comprise a control device. This can be coupled to the handling device and/or the sensor device by means of connections (e.g. by means of connecting cables or wirelessly). The control device may be configured to move the handling device and/or the tool of the handling device in response to the detection of the sensor device. In other words, the control device may move the handling device and/or the tool to a position where the tool can handle the detected closure (or closures). For example, the tool can be moved into position immediately over a detected closure. In this way, the detected closure can be handled safely.

The control device can be in the form of a computer.

At least one element of the device can, in particular all elements of the device can, be H2O2 (hydrogen peroxide) resistant, autoclavable and/or waterproof. This allows decontamination by means of H2O2 or an autoclave to be realized. This allows easy and safe decontamination or disinfection, which optimizes the use of the device in a sterile environment. The waterproof elements are suitable for washing down the device with water.

The task to be solved is further solved by a clean room. The clean room comprises a device with the features described above.

With regard to the advantages achievable with the clean room, reference is made to the explanations on the device in this respect. The measures described in connection with the device can be used for the further design of the clean room.

The task to be solved is further solved by a method for handling closures inside a clean room (e.g., an isolator of a pharmaceutical machine), in particular in a sterile environment. The method comprises the steps:

Receiving at least one closure in a receptacle. The closures can be moved, in particular poured, from a hopper system (e.g. linear conveyor, bag, container) or manually onto the receptacle. The closures can be distributed over the entire receptacle.

Setting the receptacle in vibration in such a way that the orientation and/or position of the closure received in the receptacle is changed as a result of the vibration. The vibration causes at least individual closure components to “jump” into a defined position (e.g. from lying on its side to an upright position with the closure opening facing downwards). In the process, the closures can “jump” back and forth within the entire receptacle. In particular, this allows the closures to be distributed over the entire receptacle (or receiving surface), especially chaotically.

Detecting a position, type, orientation and/or possible damage of the closure within the receptacle. In particular, a sensor device can be used for this purpose.

Moving the handling device to a position from which handling of the detected closure is possible. Preferably, such a position is located directly above the detected closure, so that the closure can be gripped from above (e.g. by means of a gripper). However, it is equally conceivable that such a position is arranged laterally with respect to a detected closure, so that the closure can be gripped laterally by means of a gripper, for example. In particular, the handling device can be moved above the, in particular entire, receptacle with respect to the direction of gravity.

Handling of the closure by means of a handling device. This can include transferring the closure to another handling device, placing the closure in a nest, closing a corresponding container with the closure, and/or transporting the closure further.

Preferably, the above method steps are carried out one after the other in the order listed. However, it is also conceivable that two or three of these method steps are carried out simultaneously or that all the method steps listed are carried out simultaneously. It is also possible to repeat a method step several times in succession.

Since the closures are already gripped/handled in the desired orientation, there is no need for re-gripping when handling the closures, for which an additional handling device and/or additional tool may be required.

However, it is conceivable that optional gripping of the closures can be provided, e.g. if the closures are aligned with the top downwards due to an unfavorable center of gravity, instead of with the top upwards as desired.

According to a further development, the receptacle and/or the closure received in the receptacle can be illuminated, in particular by means of an illumination device. This can optimize the detection of the position, type, orientation and/or possible damage to the closure.

According to a further development, a device with the features described above can be used to carry out the method. Alternatively, the method can be carried out in a clean room with the features described above.

With regard to the advantages achievable with the method, reference is made to the explanations concerning the device or the clean room. The measures described in connection with the device or the clean room can be used for the further design of the method.

It is conceivable that the receptacle can be used as a tray for a nest with closures. Such a nest could, for example, be placed on the containers complete with all closures. It is also conceivable that the closures are picked individually from the nest and placed on the containers. Thus, it could be checked by means of the sensor device, in particular a camera, whether all closures are present in the nest and/or whether the correct closures (or components) are in the nest. It is conceivable that this check can be carried out if the nest with closures is not placed on the receptacle, but is held, e.g., with the robot arm into the detection field of the sensor device (or capture window of the camera).

### BRIEF DESCRIPTION OF THE DRAWING

Further features, details and advantages of the invention are apparent from the wording of the claims and from the following description of the embodiment example based on the drawing. It shows:

FIG. 1 a perspective view of a device.

### DETAILED DESCRIPTION

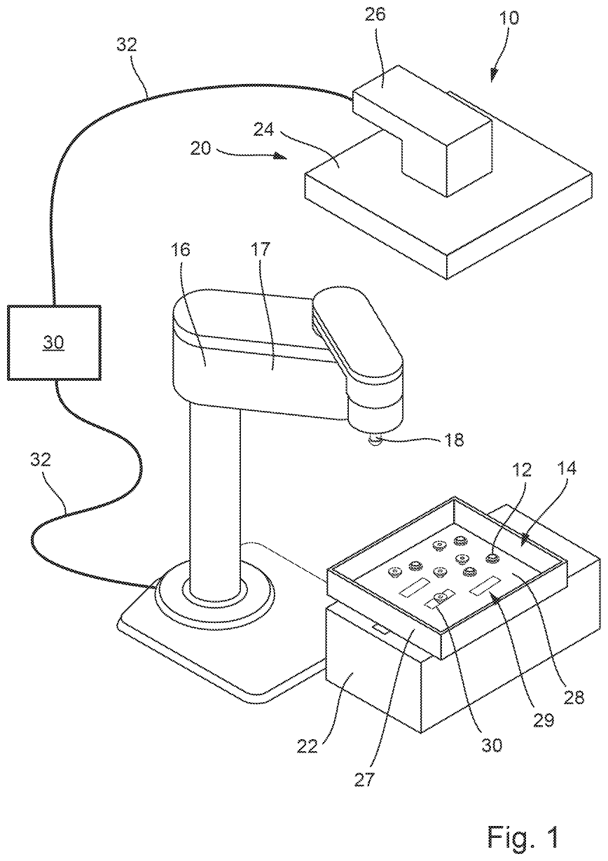

FIG. 1 shows a perspective view of a device 10 for handling closures 12 within a clean room. The device 10 has a receptacle 14.

The receptacle 14 is designed as a plate 28 with an edge 27. In other words, the receptacle 14 is tub-shaped or shell-shaped. The receptacle 14 or the plate 28 is rectangular. The edge 27 runs along the four rims of the plate 28, in other words, the edge 27 encloses the plate 28.

The receptacle 14 can securely receive a plurality of closures 12.

The device 10 also has a handling device 16. This is designed in the form of a robot arm 17. The handling device 16 has a tool 18. This is designed to be able to handle a closure 12.

The receptacle 14 can optionally be automatically upgraded with the robot arm 17.

The receptacle 14 may be designed to be format dependent. In other words, the receptacle 14 can be designed depending on the type, size, shape of the closures 12 to be received therein.

The receptacle 14 can be designed in such a way that it can be exchanged manually.

FIG. 1 shows a state of the device 10 in which the tool 18 is handling a closure 12. In other words, a closure 12 is held by means of the tool 18.

The device 10 further comprises a sensor device 20. In the present case, this is in the form of a camera 26. An illumination device 24 is arranged around the camera 26. In other words, the camera 26 is arranged within the illumination device 24.

It is conceivable that the illumination device 24 is formed separately from the camera 26, in particular is arranged at a distance from the camera 26. For example, the illumination device 24 can illuminate the receptacle 14 from the side at an angle.

In the present case, the sensor device 20 or the camera 26 and the illumination device 24 are arranged above the receptacle 14 and aligned accordingly with the receptacle 14 or in the direction of the receptacle 14. In this way, the receptacle 14 and the closures 12 accommodated therein can be optimally illuminated and their position, type, orientation and/or possible damage can be detected in a process-safe manner. It is conceivable that the illumination device 24 can be adjusted/changed in its relative position with respect to the receptacle 14 for better illumination.

The device 10 further comprises a vibration device 22. This is designed to cause the receptacle 14 to vibrate. This causes the individual closures 12 to “jump” back and forth, changing their position or orientation.

The vibration device 22 is arranged directly below the receptacle 14. The vibrating device 22 has a cuboid shape. The receptacle 14 is arranged on the vibrating device 22 so that the vibrating device 22 forms a base (holding base) for the receptacle 14.

In order to influence the “jumping behavior” of the individual closures 12 or the orientation in which the individual closures “jump”, the receptacle 14 has a structure 29. In this case, the structure 29 is in the form of elongated, slot-shaped recesses 30. These are only schematically indicated in FIG. 1.

In the present case, the recesses 30 are formed in such a way that the closures 12 can only “jump” into the recesses 30 in a certain orientation (e.g. with the closure opening facing downwards). The recesses 30 are formed complementary to the closures 12. Other types of structures, in particular complementary structures, are conceivable, for example, projections or elevations complementary to the closures 12 may also be provided. Different types of structures, or protrusions and/or recesses may be provided, for example adapted to different types of closures 12.

The device 10 further comprises a control device 30. This is coupled to the handling device 16 and the sensor device 20 by means of connections 32. Both the control device 30 and the connections 32 are shown only schematically in FIG. 1.

The connections 32 may be cable connections. However, wireless (e.g. radio, optical) connections may also be provided.

The operation of the device 10 can be described as follows:

A plurality of closures 12 are placed on the receptacle 14. Closures 12 of the same type or format are shown here. However, it is also conceivable that closures 12 of different types are placed in the receptacle 14 at the same time.

The vibrating device 22 causes the receptacle 14 to vibrate so that the closures 12 jump back and forth in the receptacle 14. In the process, the closures 12 change their position and/or their orientation. The closures 12 can be distributed over the entire receptacle 14.

After the vibration process, the camera 26 searches in the receptacle 14 for the closures 12 of the desired type (e.g. stoppers for vials) and in the desired orientation. If none of the closures 12 in the desired orientation are detected, the vibration process can be restarted. It is conceivable that if the desired orientation could not be detected even after a certain number of repetitions of a vibration process, a fault signal is output. Alternatively or additionally, further closures 12 can be inserted into and/or removed from the receptacle 14. For example, the receptacle 14 can be completely emptied.

The position of the closures 12 of the desired type and orientation is communicated to the control device 30. This controls the handling device 16 or the tool 18 in such a way that the handling device 16 or the tool 18 is moved to a position from which a closure 12 of the desired type and the desired orientation can be handled or gripped.

It is conceivable that the camera 26 detects the closures 12 already during the vibration of the receptacle 14 and sends corresponding signals to the control device 30, so that the control device 30 moves the handling device 16 or the tool 18 also already during the vibration of the receptacle 14.

Subsequently, the closures 12 can be further processed. A next processing step can be, for example, placing the closure 12 on a container (not shown) directly by the handling device 16 or transferring it to another handling device not shown. The closures 12 may also be placed in a receptacle (e.g., nest or tray) or in a parking position.

Since the closures 12 are already gripped/handled in the desired orientation, a re-gripping during the handling of the closures 12, for which an additional handling device and/or additional tool may be required, is unnecessary.

It is conceivable that the camera 26 checks the closures 12 for damage. By changing the orientation of the closures 12 when vibrating the receptacle 14, the closures 12 are detected from as many, in particular from all, sides as possible by means of the camera 26. Repositioning the camera 26 and/or changing the orientation of the camera 26 (and/or the illumination device 20) in order to detect the closures 12 from as many sides as possible is thus rendered superfluous, but may be additionally provided in order to speed up the process or make it more reliable.

If damage to a closure 12 is detected, the damaged closure 12 can be sorted out by means of the handling device 16. It is also conceivable that a further handling device (not shown) can be provided for sorting out damaged closures 12.

In the event of a malfunction or after completion of a run (batch), the receptacle 14 can be emptied automatically. The emptying of the receptacle 14 can be carried out by the handling device 16, another handling device (not shown) or by means of the vibration platform. This eliminates the need for manual intervention by an operator in the barrier system. The receptacle 14 can also be tilted for emptying, for example.

1. A device (10) for handling closures (12), inside a clean room, comprising:
a receptacle (14) for receiving at least one closure (12),
a handling device (16) having a tool (18), the tool (18) being configured to be able to handle at least one closure (12),
a sensor device (20) configured to detect a position, a type, an orientation and/or a possible damage of the closure (12) within the receptacle (14),
wherein
the device (10) further comprises a vibration device (22) which is configured to vibrate the receptacle (14) in such a way that the closure (12) received in the receptacle (14) is changed in its orientation and/or position due to the vibration.

2. The device (10) according to claim 1, wherein the sensor device (20) comprises at least one illumination device (24) configured to illuminate the receptacle (14).

3. The device (10) according to claim 1, wherein in that the sensor device (20) comprises at least one camera (26) for detecting the closure (12).

4. The device (10) according to claim 1, wherein the receptacle (14) is configured in the form of a plate (28).

5. The device (10) according to claim 1, wherein the receptacle (14) comprises a structure (29) configured to influence the position and/or orientation of the closure (12) during vibration of the receptacle (14).

6. The device (10) according to claim 1, wherein the device (10) comprises a control device (30), the control device (30) being coupled by connections (32) to the handling device (16) and/or the sensor device (20) and being adapted to move the handling device (16) and/or the tool (18) of the handling device (16) in dependence on the detection of the sensor device (20).

7. The device (10) according to claim 1, wherein at least one element of the device (10) is configured to be H2O2-resistant, autoclavable and/or waterproof.

8. A clean room with a device (10) according to claim 1.

9. A method for handling closures (12), inside a clean room, comprising the steps:
receiving at least one closure (12) in a receptacle (14),
setting the receptacle (14) in vibration in such a way that the closure (12) received in the receptacle (14) is changed in its orientation and/or position due to the vibration,
detecting a position, type, orientation and/or possible damage of the closure (12) within the receptacle (14),
moving a handling device (16) to a position from which handling of the detected closure (12) is possible,
handling the closure (12) with the handling device (16).

10. The method according to claim 9, wherein the receptacle (14) and/or the closure (12) received by the receptacle is illuminated.

11. (canceled)

12. The device (10) according to claim 1, wherein the handling device (16) is a robot arm (17).

13. The device (10) according to claim 4, wherein the plate (28) has a raised edge (27) and is configured in a shell-like manner.

14. The device (10) according to claim 7, wherein all elements of the device (10) are configured to be H2O2-resistant, autoclavable and/or waterproof.

15. The method according to claim 9, wherein the detecting step includes using a sensor device (20).

16. The method according to claim 10, wherein the receptacle (14) and/or the closure (12) received by the receptacle is illuminated by an illumination device (24).
